(19) United States
(12) Patent Application Publication
(10) Pub. No.: US 2007/0233894 A1
(43) Pub. Date: Oct. 4, 2007

(54) Shared buffer for near-end and optical interface flow control in fiber optic communications

(76) Inventors: Jing Ling, Fremont, CA (US); Jean Michel Caia, Plymooth, CA (US); Vasan Karighattam, Davis, CA (US); Juan Carlos Calderon, Fremont, CA (US); Richard D. Suffridge, Raleigh, NC (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/394,979

(22) Filed: Mar. 31, 2006

(51) Int. Cl. G06F 15/16

(52) U.S. Cl. 709/236

(57) ABSTRACT

A shared buffer for near-end and optical interface flow control in fiber optic communications is described. In one embodiment, the invention includes receiving data from a client as frames in a first format, storing the data in a addressable buffer, recording addresses for the end of each received frame, reading the stored data from the buffer for conversion to frames of a second format, and sending a ready signal to the client upon reading data stored at a recorded address for the end of a received frame.

### FIELD

The present description relates to the field of mapping data from a local area network to a wide area fiber optic network, and, in particular, to performing buffering when framing high speed LAN packets onto a subrate optical channel.

### BACKGROUND

With the advent of digital optical communications and newer higher speed electrical communications, different communication systems with different frame structures and different data rates are interconnected. This requires two kinds of buffering. A first buffer is used to hold incoming packets of one format so that they can be converted to the outgoing format. This buffer is also used adapt the instantaneous rate difference between this device and the receiving device of these packets. Another buffer is used to hold packets of data that are coming in at one rate until it can be transmitted as packets of data going out at another rate.

Fibre Channel has become popular for SANs (Storage Area Networks) and is defined as an ANSI (American National Standards Institute) communications standard for both twisted pair copper wire and for optical fiber. Due to its high speed and flexibility it has also become popular for other data communications applications beyond SANs. Sonet (Synchronous Optical Networking defined by Telcordia) and SDH (Synchronous Digital Hierarchy defined by the ITU (International Telecommunication Union)) are popular standards for long distance optical fiber data and telephone communications.

When clients on a Fibre Channel network send data over a WAN (Wide Area Network), using, for example SONET or SDH a transparent mapping approach is typically used. In order to transition the Fibre Channel packets to the WAN format, Fibre Channel offers a credit-based flow control. This is at the data link layer (FC1) which implements the 8B/10B mapping of the data. The credit-based flow control is a near-end flow control for data from the Fibre Channel client side). It asynchronously maps the 8B/10B encoded Fibre Channel client data to the WAN encoding and packet structure.

GFP (Generic Framing Procedure, defined by the ITU) allows variable length, higher-layer client signals to be mapped to a WAN transport network like SONET or SDH. GFP can be used with client data in the form of PDUs (Protocol Data Units), such as IP/PPP (Internet Protocol/Point-to-Point Protocol) or Ethernet Media access control or block codes as in Fibre Channel. GFP-T (GFP-Transparent) is particularly suited for a Fibre Channel to SONET transition because it allows multiple 8B/10B client data frames to be mapped into an efficient 64B/65B block code for transport in SONET within a GFP frame.

GFP-T applies sub-rate mapping, that is, it maps higher rate client data (e.g., 1G Fibre Channel) into lower rate SONET payload (e.g., STS-3c or 155 Mbps). GFP-T sub-rate may be used whether or not the device at the other end of the WAN implements far-end flow control. Far-end flow control is applied to data coming from a SONET connection to transition the data to another communications standard.

For Fibre Channel data, near-end flow control is typically effective for distances over the WAN of up to 80 km. So for distances of up to 80 km, the on-chip memory of a transition device is normally sufficient to provide the buffer to store the data. In an implementation where the GFP-T adaptation function is implemented in one device and the GFP framing function is implemented in a second separate device, two buffers, typically FIFOs (First In First Out) are required in the first device. For GFP-T adaptation in the direction from client to SONET a first FIFO is used for near-end flow control, and a second FIFO is used for the packet interface (e.g., SPI-4 (System Packet Interface rev. 4 of the Optical Networking Forum)) between the GFP-T rate adaptation device and the GFP framing device. Multiple buffers add expense and delay to the system in the cost of memory as well as any protocols and processes for moving packets into and out of the buffers.

### BRIEF DESCRIPTION OF THE DRAWINGS

Embodiments of the present invention will be understood more fully from the detailed description given below and from the accompanying drawings of various embodiments of the invention. The drawings, however, should not be taken to be limiting, but are for explanation and understanding only.

FIG. 1 is a block diagram of a an interface between a network of local area network clients and a cross-connect to a wide area optical network according to an embodiment of the invention;

FIG. 2 is a block diagram of the client adaptation FPGA of FIG. 1 according to an embodiment of the invention;

FIG. 3 is a block diagram of an alternate version of the client adaptation FPGA of FIG. 1 according to an embodiment of the invention;

FIG. 4 is a block diagram of another alternate version of the client adaptation FPGA of FIG. 1 according to an embodiment of the invention; and

FIG. 5 is a process flow diagram of buffering packets within the client adaptation FPGA of FIG. 1 according to an embodiment of the invention.

### DETAILED DESCRIPTION

A single buffer, such as a FIFO may be shared by a SPI-4.2 interface (System Packet Interface Level 4 (SPI-4) Phase 2 Revision 1: OC-192 System Interface for Physical and Link Layer Devices, published Jun. 12, 1992), or any other packet interface, and a near-end flow control function for Fibre Channel or similar clients. The single buffer may also be used to effectively reduce the total buffer size to approximately half the typical size without losing functionality in the GFP functions. This reduces cost and complexity and, when the functions are implemented in standardized modules, such as an FPGA (Field Programmable Gate Array), the choice of available modules is greatly enhanced.

This allows Fibre Channel clients to be transported over SONET at much less cost. When the two buffers are combined the size of the combined FIFO may often be approximately equal to the size of the larger of the two FIFOs. The particular size will depend, in part, on the required FIFO size for each function.

In one embodiment, the invention may be part of a client adaptation FPGA, a companion chip for a service framer, such a device may be sold as a Bandwidth Aggregation and Channelizer Devices with Virtual Concatenation. A client adaptation FPGA expands the service framer's capabilities to transport multiple types of data clients (e.g. Fiber Channel, Gigabit Ethernet, FICON (Fiber Connectivity defined by IBM Corp.), ESCON (Enterprise Systems Connection defined by IBM Corp.), etc), and thereby allows the service framer to be used in more applications and in applications in which it will be coupled to several different networks simultaneously. The client adaptation FPGA may also be useful when Fibre Channel data is transparently encoded then transported over a SONET channel. It may also be useful when the GFP framing function is implemented in a different device than the GFP-T adaptation function.

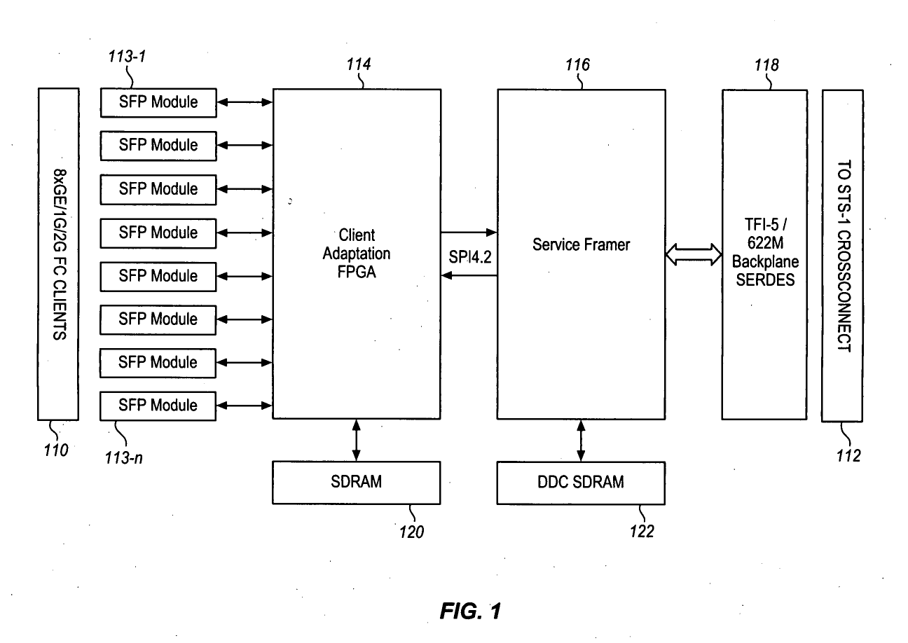

FIG. 1 shows an example of an interface between a network of Fibre Channel clients 110 and a cross-connect with STS-1 (Synchronous Transport Signal) granularity. Such a configuration may be used in a router line card, a client adaptation line card, digital cross connect aggregation blades and other devices. The two end nodes of the interface are provided as examples only. Embodiments of the invention may be applied to other types of client communication systems and other types of WAN systems. Embodiments of the invention may also be applied to future updates and successors to any of the formats, protocols, transports and systems mentioned herein. The specific named, formats, protocols, transports and systems are provided in order to provide a clear and definite context for the description. In one example, the STS cross-connect may be replaced with a STM (Synchronous Transport Module) cross-connect for an SDH WAN. The STS cross-connect serves as a direct interface to the WAN physical layer.

The interface of FIG. 1 may form part of a communication system, in which Fibre Channel client data is transported over SONET or OTN (Open Transport Network) through a TDM Cross-Connect Switch. Between these two data formats, there is a Client Adaptation FPGA 114 coupled to the client data network through a set of SFP (Small Form Factor Pluggable) modules 113-1 to 113-n. In the present example, this FPGA implements the GFP-T adaptation function. The SFP modules translate optical signals into electrical signals. While the client adaptation module is shown as described as an FPGA, other device architectures may be used. The module may be programmed in firmware and not later reprogrammable. The module may also be implemented as an ASIC (Application Specific Integrated Circuit), a DSP (Digital Signal Processor) or in any of a variety of other forms.

A service framer 116 is coupled to the Client Adaptation FPGA using, for example SPI-4.2, a packet based interface. The service framer performs the GFP framing function. The service framer is coupled to a Backplane SERDES (Serializer/Deserializer) 118 that couples the reframed data to the STS cross-connect. FIG. 1 also shows an SDRAM (Synchronous Dynamic Random Access Memory) module 120 that is coupled to the client adaptation FPGA for its use and a DDC (Differential Delay Compensation) SDRAM coupled to the service framer for its use.

When a Fibre Channel client transmits data to send over a SONET network, it is transparently mapped over a SONET payload, typically using virtual or contiguous concatenation, although other approaches may also be used. Due to the difference in data rates, or more specifically, when the SONET payload rate is less than the Fibre Channel data rate, near-end flow control is used to prevent the Fibre Channel data source from transmitting data when the SONET side cannot handle it. The near-end flow control is normally used irrespective of whether FC-BB-3_SONET far-end flow control or some other far-end flow control is used at the other end of the WAN. A popular near-end flow control approach is a credit based Fibre Channel buffer-to-buffer flow control.

According to the credit based approach, for a 1G Fibre Channel client approximately 1 credit is required for every 2 km, plus 2 credits to store 2 extra Fibre Channel frames to account for any partial frames in transmission. For 2G/4G Fibre Channel clients, the number of credits required per kilometer is proportional to that for a 1G Fibre Channel. In other words, the 2G client requires 2 credits for every 2 km and the 4G client requires 4 credits for every 2 km. To support 20 km of near-end flow control for a network of 1G Fibre Channel clients, the number of required credits can be computed as 20 km/2 km per credit+2 buffer credits=12 credits. Each credit represents 1 Fibre Channel frame and in a typical Fibre Channel network, the maximum frame size is 2148 bytes. Accordingly, the required FIFO size is about 25.2 Kbytes.

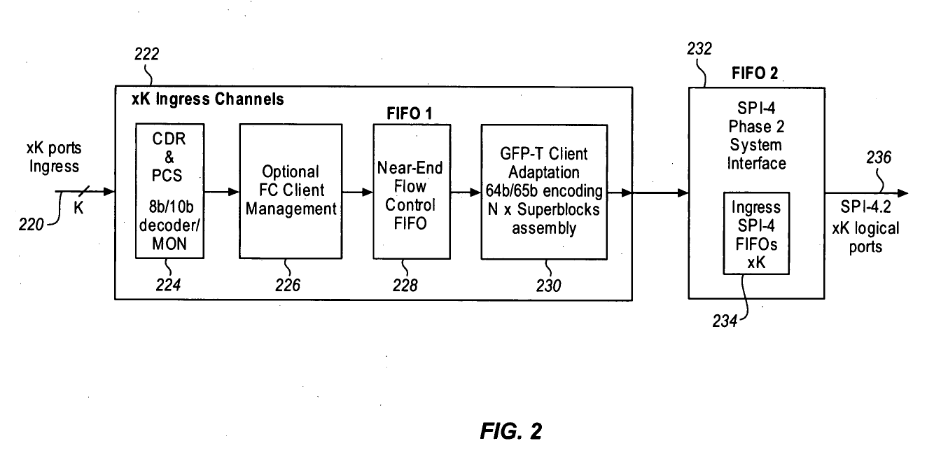

FIG. 2 shows a portion of the client adaptation FPGA 114 of FIG. 1 in block diagram form. Packets from the Fibre Channel network enter the FPGA through the SFP modules as shown by the line 220. Line 220 represents ×K ports. While one port is shown, the elements of FIG. 2 may be reproduced K times for a complete system. The FPGA supports the ×K ingress channels in an ingress section 222. The packets arrive at a CDR & PCS (Clock and Data Recovery and Physical Coding Sub-layer) module 224 that converts the data to an 8B/10B format. This module may also perform various monitoring functions (MON).

The packets are then passed to a Fibre Channel Client Management module 226 to remove IDLE, R_RDY and control frames, if necessary. The packets are then stored in a near-end flow control FIFO 228 before being passed, when ready to a GFP-T client adaptation module 230. This module performs 64B/65B encoding and assembles the superblocks for the WAN. Any one or more of these blocks may be consolidated into other blocks and some functions may be removed while others are added, depending on the implementation.

From the ingress channels section, the reformatted and buffered packets are passed to a SPI-4.2 system interface 232 that includes its own ingress FIFO buffer 234. After conversion to SPI-4, the FPGA offers K logical egress ports 236 to the service framer. While the present description is in the context of SPI-4 Phase 2, it may also be adapted to later versions of SPI as well as other data communication protocols.

As shown in FIG. 2, in the ingress direction of the client adaptation FPGA (from a client towards the SONET network), there is one FIFO used for Fibre Channel buffer-to-buffer flow control (FIFO 1). Another FIFO is used for the SPI-4.2 interface (FIFO 2). If the client adaptation FPGA can be used to transport other types of traffic, such as Gigabit Ethernet, the size of the SPI-4.2 interface FIFO can be as large as 16 Kbytes or 32 Kbytes per port/client, in order to store 1 or 2 Ethernet jumbo frames.

The two FIFOs support different functionality and are logically implemented separately. The flow control FIFO (FIFO 1) stores Fibre Channel frames and interfaces with the Fibre Channel network. For example when a frame is sent out of this FIFO , the near-end flow control may determine when to send R_RDY back to the Fibre Channel source indicating that it is ready to receive another frame. In the SPI-4 FIFO (FIFO 2), only N superblocks are counted as a packet and there is no connection or interface with Fibre Channel and Fibre Channel frames do not exist here. In the present example N indicates the number of superblocks; for example, N=13 for Fibre Channel.

The two large FIFOs consume significant resources on the FPGA. In many FPGA designs, the amount RAM available for all purposes is limited. In addition, in FPGA design, where the size of the RAMs are fixed, it may be more efficient to use the RAMs to implement one large FIFO rather than two smaller FIFOs. As shown in FIG. 2, FIFO 1 (used for near-end flow control) may be moved to FIFO 2 (used for SPI-4.2).

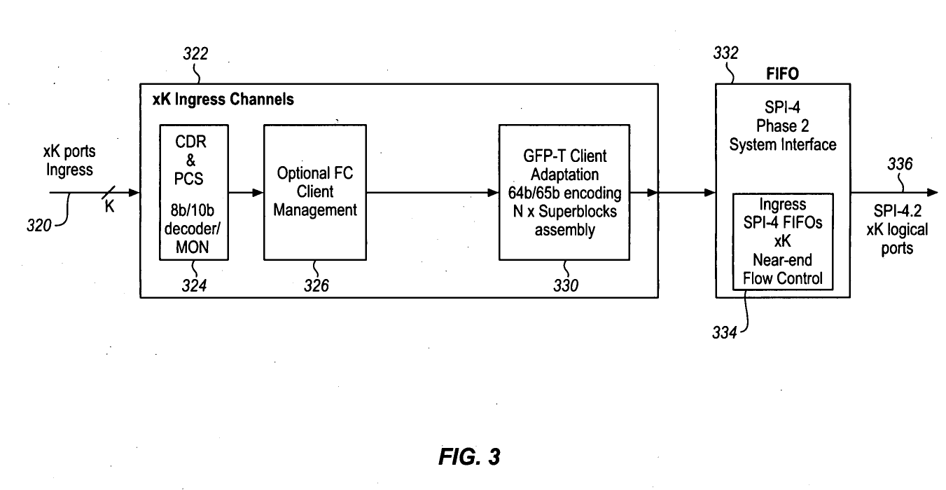

FIG. 3 shows a portion of an alternate client adaptation FPGA 114 of FIG. 1 in block diagram form. Packets from the Fibre Channel network enter the FPGA at an ingress section 322 through one of K ingress ports as shown by the line 320. The packets are first processed at a CDR & PCS module 324 and are then passed to an optional Fibre Channel Client Management module 326. The packets are then passed directly without buffering to a GFP-T client adaptation module 330.

From the ingress section 322, the packets go to a SPI-4 system interface 332 that includes a single FIFO 334 for the ingress SPI packets and for near-end flow control. The packets then exit through one of K logical ports 336 to the service framer.

To accommodate the lack of a dedicated flow control FIFO, the SPI-4 FIFO may be adapted to keep track of the end of the frames in the 64B/65B encoded data from the GFP-T mapping 330. In one example, when data is received from the client and passes through the Fibre Channel Client Management block 326, the end of each frame is detected and then stored in the SPI-4 FIFO. The end of each frame may be tracked by recording the address of each end-of-frame in the SPI-4 FIFO. This storage of EOF (end-of-frame) records may normally be done by the dedicated flow control FIFO (FIFO 1).

The maximum number of EOF records that is stored may be set as the maximum number of credits that can be supported. For example, if the maximum number of supported credits is 12, then only 12 EOF addresses need to be stored. Some near end buffer-to-buffer flow control systems are limited so that no more than 12 frames should be sent by the Fibre Channel source at any point of time. No additional resources or very little additional resources are required for this operation. To manage near-end flow, an EOF record may be sent out on the SPI-4 interface to the SPI-4 system interface module when the end of a frame is reached in the FIFO. The SPI-4 system interface may then instruct other blocks in the FPGA to send an R-RDY back to the Fibre Channel source to indicate that another credit is available. The Fibre channel source may then send another packet.

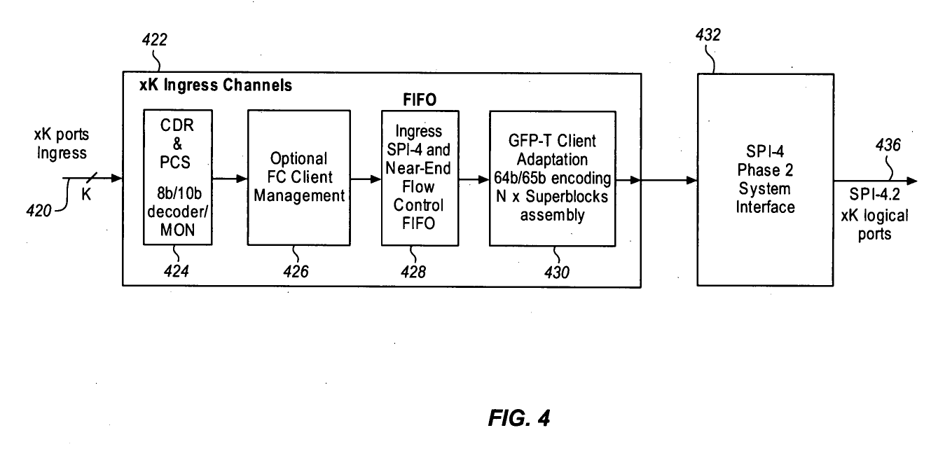

FIG. 4 shows a portion of another alternate client adaptation FPGA 114 of FIG. 1 in block diagram form. Packets from the Fibre Channel network enter the FPGA at an ingress section 422 through one of K ingress ports as shown by the line 420. The packets are first processed at a CDR & PCS module 424 and are then passed to an optional Fibre Channel Client Management module 426. The packets are then buffered in a near-end flow control FIFO 428 which also performs SPI-4 ingress buffering. The packets then travel to a GFP-T client adaptation module 430 to perform 64B/65B encoding and assemble the superblocks for the WAN. There may also be a FC-BB-3_SONET WAN Processor (not shown) for ASFC (Alternate Simple Flow Control) functions to receive packets from the FIFO before they are passed to the GFP-T encoding. This allows compliance with FC-BB-3_SONET processing, when desired for a particular application.

From the ingress section 422, the packets go to a SPI-4 system interface 432 that does not include a FIFO for the ingress SPI packets. The packets then exit through one of K logical ports 436 to the service framer.

To accommodate the lack of a dedicated SPI-4 ingress FIFO, the near-end flow control FIFO may be adapted to keep track of the ingress demands of the SPI-4 system interface and send data to the GFP-T mapping module at a rate that will satisfy the demands of the SPI-4 system interface.

The embodiment of FIG. 4 removes FIFO 2 used in the embodiment of FIG. 2 to store the GFP frame payloads carried through the SPI-4.2 interface (N×superblocks) and implements the buffering required to absorb the SPI-4.2 burstiness in the near end Flow Control FIFO. This allows, for example the delay constraint specified by FC-BB-3 regarding the ASFC (Alternate Simple Flow Control) response time to the received PAUSE/RESUME WAN Primitive Signals to be met.

On the other hand, the implementation of the GFP-T 64B/65B enconding and the FC-BB-3 WAN functions (ASFC) is more complex because these functions are centralized into a single time-sliced machine processing K different client flows simultaneously. In addition, this configuration in which the 64B/65B enconding and the FC-BB-3 WAN blocks appear between the Ingress FIFOs and the SPI-4.2 interface complicates the support of store-and-forward transfers through the SPI-4.2 interface.

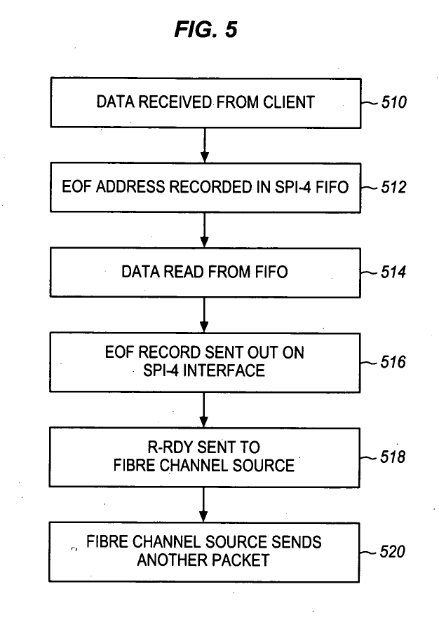

FIG. 5 shows an example process flow according to one embodiment of the invention. In FIG. 5 at block 510, Fibre Channel data is received from the Fibre Channel client through the ingress channel. At block 512, an EOF address is recorded in the SPI-4 FIFO that identifies the end of each packet received from the Fibre Channel client. In the example of FIG. 2, these packets are already presented as N×superblocks in 64B/65B encoding. At block 514, the stored packet data is read from the FIFO for use by the SPI interface system. At block 516, the EOF record is sent out on the SPI-4 interface.

At block 518, the SPI-4 system interface reads the EOF record and sends a command to the packet source indicating that there is additional room in the buffer. For a Fibre Channel source, the command may be an R-RDY command. In response to such a command, at block 520, the Fibre channel source sends another packet.

With 64B/65B encoding, a packet consists of N×superblocks and is only completed when all N superblocks are encoded. In the store-and-forward mode of SPI-4, a packet will not be sent until N superblocks are received by the SPI-4 FIFO. In the cut-through mode, if the last part of a packet is not sent in time, an underflow will occur in the GFP mapper in the GFP framing device. Therefore, when the SPI-4 FIFO is close to empty (in store-and-forward mode) and when there is only one partial packet remaining in the SPI-4 FIFO and the partial packet is insufficient to fill the 64B/65B packet, then the last part of a packet (N×superblocks) may be sent to the SPI-4 FIFO by filling up the last part of the packet with 65B_PAD. This function may be performed with or without a dedicated near-end control FIFO. Padding the end of a 64B/65B packet will not increase the size requirement for the flow control FIFO, because this padding only happens when the SPI-4 FIFO is close to empty and the output rate from the SPI-4 is constant. In other words, it is matched to the input rate of the SONET WAN.

In one example, the required size of the combined FIFO may be calculated as follows. For each frame, with the maximum frame size of 2148 bytes, the required buffer after 64B/65B encoding (including CRC-16 (Cyclic Redundancy Check)) is 2148×67/64 or about 2249 bytes. To support 20 km of near-end flow control, 12 credits or 2249×12=26.4 Kbytes are used. If a SPI-4 FIFO of 32 Kbytes is required for the FIG. 1 example, then the FIFO size for the FIG. 2 version is the same as the FIFO 2 for the FIG. 1 version, and is much smaller than the combined size of FIFO 1 and FIFO 2 for the FIG. 1 version (32+25.2 Kbytes). If a SPI-4 FIFO size of 16 Kbytes is required for the FIG. 1 FIFO 2, then the required combined SPI-4 FIFO size for the FIG. 2 version is about 26.4 Kbyte, which is much less than 16+25.2 Kbytes. Accordingly, by combining these two FIFOs, the required on-chip RAM size can be significantly reduced without losing any functionality.

A lesser or more complicated line router, client adaptation module, client management module, near-end or far-end flow control, buffer-to-buffer flow control, encoding/decoding, packetizing, serializing/desterilizing, wired or optical network may be used than those shown and described herein. Therefore, the configurations may vary from implementation to implementation depending upon numerous factors, such as price constraints, performance requirements, technological improvements, or other circumstances. Embodiments of the invention may also be applied to other types of systems that use different inputs and outputs than those shown and described herein.

Embodiments of the present invention may be provided as a microcode, firmware, embedded instructions, or a computer program product which may include a machine-readable medium having stored thereon instructions which may be used to program a general purpose processor, embedded processor or application specific device (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and apparatus are described in their most basic form but steps may be added to or deleted from any of the methods and components may be added or subtracted from any of the described apparatus without departing from the basic scope of the present invention. It will be apparent to those skilled in the art that many further modifications and adaptations may be made. The particular embodiments are not provided to limit the invention but to illustrate it. The scope of the present invention is not to be determined by the specific examples provided above but only by the claims below.

What is claimed is:

1. A method comprising:
receiving data from a client as frames in a first format;
storing the data in an addressable buffer;
recording addresses for the end of each received frame;
reading the stored data from the buffer for conversion to frames of a second format; and
sending a ready signal to the client in response to reading data stored at a recorded address for the end of a received frame.

2. The method of claim 1, further comprising receiving further data from the client as frames in the first format in response to sending the ready signal.

3. The method of claim 1, wherein the first frame format comprises encoded superblocks.

4. The method of claim 1, wherein conversion to frames of a second format comprises converting frames to a System Packet Interface format.

5. The method of claim 1, wherein reading the stored data comprises reading the data at a rate coupled to the rate of the conversion to frames of the second format.

6. The method of claim 1, wherein storing the data comprises storing the data at a rate coupled to the rate of the frames of the first format.

7. The method of claim 1, wherein storing and reading comprise data flow buffering for the conversion to the frames of the second format.

8. The method of claim 1, wherein recording and sending comprise near end flow control for receiving data from the client.

9. A machine-readable medium comprising data that when operated on by the machine cause the machine to perform operations comprising:
receiving data from a client as frames in a first format;
storing the data in a addressable buffer;
recording addresses for an end of each received frame;
reading the stored data from the buffer for conversion to frames of a second format;
sending a ready signal to the client in response to reading data stored at a recorded address for the end of a received frame.

10. The medium of claim 9, further comprising data causing the machine to perform further operations comprising receiving further data from the client as frames in the first format in response to sending the ready signal.

11. The medium of claim 1, wherein reading the stored data comprises reading the data at a rate coupled to the rate of the conversion to frames of the second format.

12. An apparatus comprising:
a plurality of ingress channels to receive data from a client as frames in a first format;
an encoder to convert the data into frames of a second format; and
a combined near-end flow control and output encoder addressable buffer to store data from a client at one rate and provide it to the wide area network at another rate.

13. The apparatus of claim 12, wherein the buffer records addresses for an end of each received frame and sends a ready signal to the client in response to reading data stored at a recorded address for the end of a received frame.

14. The apparatus of claim 13, wherein the encoder is to read the stored data from the buffer for conversion to frames of a second format.

15. The apparatus of claim 14, wherein the buffer further is to receive data from the client as frames in the first format in response to sending the ready signal.

16. The apparatus of claim 12, further comprising a client manager module to remove control frames from the received data before being stored in the buffer.

17. The apparatus of claim 12, further comprising a decoder to decode data received from a client before storing in the buffer.

18. A line card comprising:
a plurality of client interface modules to receive data from a plurality of clients as frames in a first format;
a decoder to decode the data from the first format;
an encoder to convert the data into frames of a second format;
a service framer to frame data in the second format for transmission over the wide area network; and
a combined near-end flow control and output encoder addressable buffer to store data from a client at one rate and provide it to the wide area network at another rate.

19. The line card of claim 18, wherein the first frame format comprises encoded superblocks.

20. The line card of claim 19, wherein converting into frames of a second format comprises converting frames to a System Packet Interface format.
